(19) United States
(12) Patent Application Publication
(10) Pub. No.: US 2015/0212620 A1
(43) Pub. Date: Jul. 30, 2015

(54) Touch Panel And Touch Screen Having The Same

(71) Applicant: Dongbu Hitek Co., Ltd., Seoul (KR)

(72) Inventor: Kwang Hyun Kim, Gyeonggi-do (KR)

(21) Appl. No.: 14/300,960

(22) Filed: Jun. 10, 2014

(30) Foreign Application Priority Data
Jan. 28, 2014 (KR) 10-2014-0010650

(51) Int. Cl. G06F 3/044

(52) U.S. Cl. CPC G06F 3/044; G06F 2203/04111

(57) ABSTRACT

Disclosed is a touch panel for recognizing touch of a conductor and a touch screen including the same. The touch panel for recognizing touch of a conductor includes: a driving line extending in a first direction; and a sensing line disposed on the driving line to extend in a second direction crossing the first direction. The sensing line includes a main line extending in the second direction and a plurality of branch lines connected to the main line.

### CROSS-REFERENCE TO RELATED APPLICATION

This application claims priority to Korean Patent Application No. 10-2014-0010650 filed on Jan. 28, 2014 and all the benefits accruing therefrom under 35 U.S.C. §119, the contents of which are incorporated by reference in their entirety.

### BACKGROUND

The present disclosure relates to a touch panel and a touch screen having the same, and more particularly, to a touch panel that detects a variation in mutual capacitance generated between driving lines and sensing lines and a touch screen having the same.

In general, touch panels through which a user directly contacts a screen by using a finger or pen to input information may be used as input device for personal computers, mobile communication devices, and other private information processing devices.

Touch panels offer several advantages over other input methods. For example, touch panels typically have fewer malfunctions, are easily portable, character input is enabled without requiring the use of other input devices, and input methods are cleared defined for users. Thus, touch panels may be applicable to various information processing devices in recent years.

Touch panels may be classified into various types according to the method of detecting user touch input. For example, these types may include ultrasonic touch panels, electrostatic capacitive touch panels, resistive touch panels, electromagnetic touch panels, and optical sensor touch panels.

Resistive touch panels may function by detecting a voltage gradient caused by resistance that varies when touched by the user. This resistance is measured to determine a touched position. As a result, an analog-to-digital converter is needed to convert the analog resistance measurement to a digital reading. Thus, if the resistance cannot be clearly measured, the touch panel may have difficulty in providing accurate touch readings.

In the case of the optical sensor touch panels, it may be difficult to determine a touched position when an optical path between an optical output device and an optical input device is blocked.

Electromagnetic touch panels may use principles of electromagnetic force to detect touch locations. For example, a separate stylus pen incorporating an electromagnetic coil may be required to provide input to such devices.

In the case of the ultrasonic touch panels, it may be difficult to determine a touched position when a sound path between a sound output device and a sound input device is blocked. Thus, the ultrasonic type may be vulnerable to surrounding noises.

When compared to the above-described touch types, electrostatic capacitive touch panels may provide an advantage in that such panels may have strong impact resistance and less affected by ambient noise. Thus, the electrostatic capacitive touch panels are increasing in popularity.

Such touch panels are typically implemented using mutual capacitance techniques. Mutual capacitance touch panels may be implemented by a technique in which a conductive layer constituting a touch panel has equipotentiality to sense a capacitance value that varies on a top surface thereof when a conductor contacts thereon, thereby recognizing a touch input by user. That is, in the mutual capacitance type touch panel, a driving line that is an X-axis electrode row and a sensing line that is a Y-axis electrode row may cross each other to form a matrix form, and then, when a specific position on the matrix form is touched, mutual capacitance that varies at the specific position may be measured to sense a touched position. Hereinafter, a mutual capacitance method will be described with reference to FIG. 1.

FIG. 1A illustrates a state in which in which capacitive coupling occurs between a driving line and a sensing line when driving current flows into the driving line when the touch panel is not touched, and FIG. 1B is a view illustrating a state in which mutual capacitance varies when the touch panel is touched.

Referring to FIG. 1A, mutual capacitance may be classified into parasitic capacitance Ca occurring in a region in which the driving line and the sensing line vertically overlap each other and fringe capacitance Cb occurring at a fringe of the sensing line that does not overlap the driving line.

Referring to FIG. 1B, when a hand corresponding to the conductor is touched, mutual capacitance between the sensing line and the driving line may vary. In more detail, a portion of the fringe capacitance Cb occurring at the fringe of the sensing line may be coupled to a hand to thereby reduce an amount of mutual capacitance.

That is, in the mutual capacitance method for detecting touch input, an amount of mutual capacitance that varies as described above may be measured to calculate a touch coordinate. Particularly, since an amount of fringe capacitance Cb is proportional to variation in mutual capacitance, as the fringe capacitance Cb increases, touch sensitivity may increase.

However, since each of the sensing line and the driving line has a bar-type structure with a relatively wide width, the parasitic capacitance Ca may be greater than the fringe capacitance Cb because of the wide overlapping area therebetween.

In case of the bar type, when a peripheral portion is touched but an upper portion of the sensing line is not touched, the variation of the mutual capacitance may be less, thus causing touch resolution to deteriorate.

Because of this reduced touch resolution, a stylus pen may be needed to accurately sense the touched coordinate. The stylus pen may be gradually reduced in diameter to a point in order to improve the touch resolution.

In order to provide accurate touch input coordinates and to facilitate the use of modern touch panels, improved methods for accurately detecting a touch coordinate at a specific point and detecting touch patterns generated when a touch point moves in the touched state are required.

### SUMMARY

The present disclosure provides a touch panel having improved accuracy and linearity and a touch screen having the same.

In accordance with an exemplary embodiment, a touch panel for recognizing a touch of a conductor includes a driving line extending in a first direction, and a sensing line disposed on the driving line to extend in a second direction crossing the first direction. The sensing line includes a main line extending in the second direction and a plurality of branch lines connected to the main line.

The sensing line may further include a first sub line spaced by a particular distance from one side of the main line to extend in the second direction, and a second sub line spaced by a particular distance from another side of the main line to extend in the second direction.

Each of the branch lines may be connected with one of the first and second sub lines.

Each of the first and second sub lines may have a sub line width that corresponds to a quarter of that of the main line.

Each of the branch lines may extend in the first direction.

Each of the branch lines may extend in a diagonal direction with respect to one of the first and second directions.

Each of the branch lines may have a branch line width gradually decreasing in a direction that is away from the main line.

One end of each of the branch lines connected to the main line may has a branch line width that corresponds to a half of that of the main line, and another end of each of the branch lines may has a branch line width that corresponds to two fifteenths of the main line.

The touch panel may further include a driving unit configured to apply a driving signal to the driving line.

The touch panel may further include a sensing unit configured to detect mutual capacitance that varies by the touch to calculate a touch coordinate.

In accordance with another exemplary embodiment, a touch screen for recognizing touch of a conductor and outputting an image includes a display, a driving line disposed on the display to extend in a first direction, a sensing line disposed on the driving line to extend in a second direction crossing the first direction, a driving unit configured to apply a driving signal to the driving line, and a sensing unit configured to detect mutual capacitance that varies by the touch to calculate a touch coordinate. The sensing line includes a main line extending in the second direction and a plurality of branch lines connected to the main line.

The sensing line may further include a first sub line spaced by a particular distance from one side of the main line to extend in the second direction, and a second sub line spaced by a particular distance from the other side of the main line to extend in the second direction.

Each of the branch lines may be connected to one of the first and second sub lines.

Each of the branch lines may extend in the first direction.

Each of the branch lines may extend in a diagonal direction with respect to one of the first and second directions.

Each of the branch lines may have a branch line width gradually decreasing in a direction that is away from the main line.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Exemplary embodiments can be understood in more detail from the following description taken in conjunction with the accompanying drawings which are not necessarily drawn to scale, in which:

FIG. 1A illustrate a state in which in which capacitive coupling occurs between a driving line and a sensing line when driving current flows into the driving line without being touched, and FIG. 1B is a view illustrating a state in which mutual capacitance varies when touched;

FIG. 2 is a cross-sectional view of a touch screen panel display device;

FIG. 3 is a plan view of a touch panel including a bar-type sensing line;

FIG. 4 is a plan view illustrating a pattern of a sensing line in one pixel in accordance with a first embodiment;

FIG. 5 is a plan view illustrating a pattern of a sensing line in one pixel in accordance with a second embodiment;

FIG. 6 is a plan view illustrating a pattern of a sensing line in one pixel in accordance with a third embodiment;

FIG. 7 is a view of a touch panel in accordance with the third embodiment;

FIG. 8 is a view for explaining a vibration in mutual capacitance when a specific position on the touch panel is touched in accordance with the third embodiment; and

FIG. 9 is a view for explaining a variation in mutual capacitance when a touch pattern traveling in a horizontal direction is inputted on the touch panel in accordance with the third embodiment; and

FIG. 10 is a view for explaining a variation in mutual capacitance when a touch pattern traveling in a diagonal direction is inputted on the touch panel in accordance with the third embodiment.

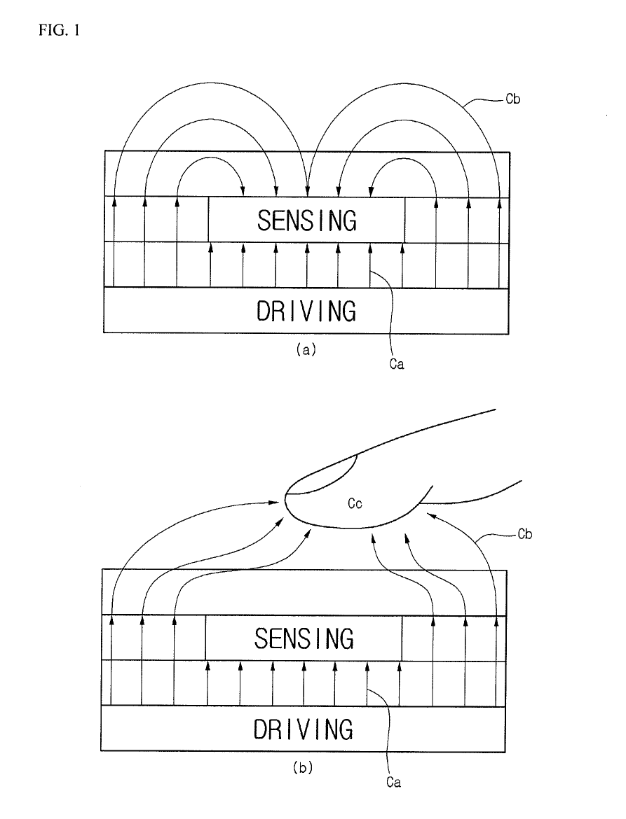

### DETAILED DESCRIPTION OF EMBODIMENTS

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the inventive concept to those skilled in the art.

It will also be understood that when an element or layer is referred to as being ‘on’ another element or layer, it can be directly on the other element or layer, or one or more intervening elements or layers may also be present. On the other hand, it will be understood that when an element is directly disposed on or connected to another one, further another element cannot be present therebetween. Also, though terms like a first, a second, and a third are used to describe various elements, compositions, areas and/or layers in various embodiments of the inventive concept, the elements, compositions, areas and/or layers are not limited to these terms.

In the following description, technical terms are used only for explaining specific exemplary embodiments. These terms are not intended to be limiting. Also, unless otherwise defined, all terms, including technical and scientific terms used herein have the same meaning as commonly understood by one of ordinary skill in the art to which the invention pertains.

Some embodiments of the invention are described with reference to the schematic diagrams illustrated. Accordingly, deviations from these schematic diagrams are to be expected in accordance with expected production methods and tolerances. Thus, illustrations of embodiments of the invention may be described with respect to particular portions of devices, processes, and the like incorporating said embodiments, and it should be understood that such embodiments may include other features not explicitly shown in the illustrations. Furthermore, such illustrations may not be drawn to scale, and the size, shape, and other measurements of features in the illustrations is not intended to limit the scope of the claimed invention.

In some embodiments, a pattern of a sensing line may be optimized to improve accuracy and linearity in touch so as to improve mutual capacitance in a mutual capacitance type touch panel and touch screen structure, thereby improving touch sensitivity.

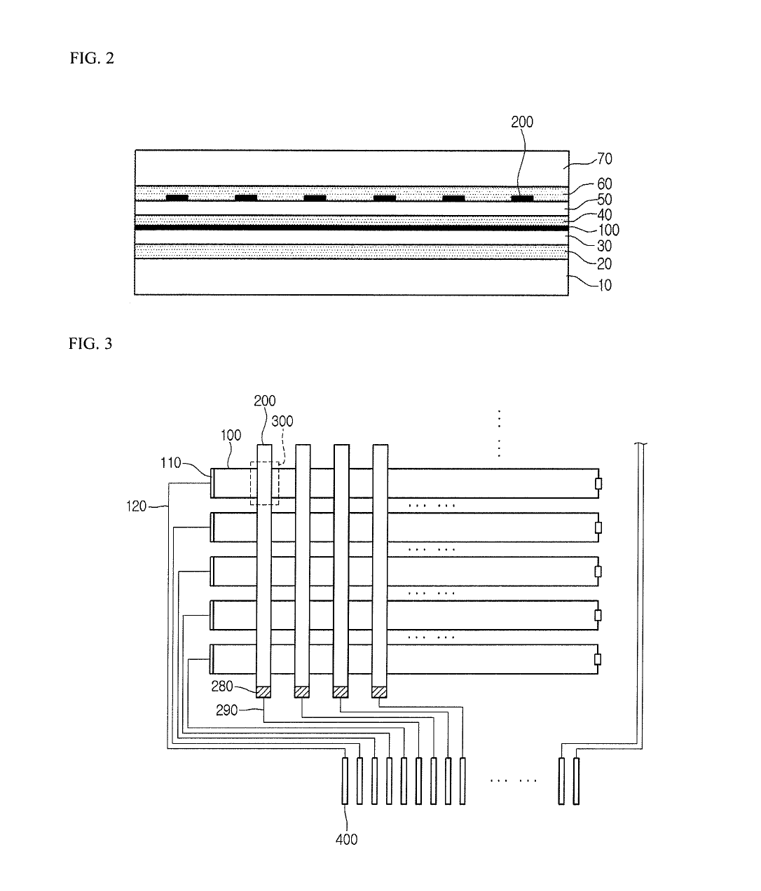

FIG. 2 is a cross-sectional view of a touch screen panel display device, and FIG. 3 is a plan view of a touch panel including a bar-type sensing line. Hereinafter, structure of a touch panel and touch screen will be described with reference to FIGS. 2 and 3.

Although the touch screen panel display device illustrated in FIG. 2 is provided as a Glass Film Film (GFF) type, the technical ideas of the inventive concept may be applied to all film electrode type touch panels such as Glass 1 Film (G1F),Glass Film Ditto (GF2) and/or other glass type touch panels.

Referring to FIG. 2, a touch screen panel display device may include a display 10, an X-axis Indium Tin Oxide (ITO) film 30 stacked on the display 10, driving lines 100 including a plurality of electrodes that extend in an X-axis direction (a first direction) on a top surface of the X-axis ITO film 30, a Y-axis ITO film 50 stacked on the X-axis film 30 and the driving lines 100, sensing lines 200 including a plurality of electrode that extend in a Y-axis direction (a second direction) on a top surface of the Y-axis ITO film 50, and a window glass 70 stacked on the Y-axis ITO film 50 and the sensing lines 200.

Optical clear adhesive layers 20, 40, and 60 may be disposed between the display 10 and the X-axis ITO film 30, between the X-axis ITO film 30 and the Y-axis ITO film 50, and between the Y-axis ITO film 50 and the window glass 70, respectively.

Referring to FIG. 3, the touch panel may include a plurality of driving lines 100 extending in the X-axis direction and are arranged in the Y-axis direction and sensing lines 200 extending in the Y-axis direction on the driving lines 100 and arranged in the X-axis direction. The driving lines 100 and the sensing lines 200 cross each other in a grid or matrix form to constitute a coordinate of the touch panel.

For example, the driving lines 100 may be bar-shaped transparent electrodes each of which has a particular width and extends in the X-axis direction.

First contact parts 110 may be disposed on ends of the driving lines 100, respectively. The first contact parts 110 may be connected to a driving unit (not shown) through first trace lines 120 that are disposed on an outer portion of the touch panel and ports 400 respectively connected to the first trace lines 120.

The driving unit may apply a driving signal to the driving lines 100 to induce capacitive coupling between the driving lines 100 and the sensing lines 200, thereby operating the touch panel.

When the driving lines 100 extend in the X-axis direction, the sensing lines 200 may extend in the Y-axis direction on the driving lines 100 to cross the driving lines 100. For example, the sensing lines 200 may be bar-shaped transparent electrodes each of which has a particular width and extends in the Y-axis direction.

Second contact parts 280 may be disposed on ends of the sensing lines 200, respectively. The second contact parts 280 may be connected to a sensing unit (not shown) through second trace lines 290 that are disposed on an outer portion of the touch panel and ports 400.

The sensing unit may measure mutual capacitance that varies by touch of a conductor to calculate a coordinate of a point at which the mutual capacitance varies, as a touched portion.

For example, when the driving unit applies a driving signal to a specific driving line 100, if a specific point on the specific driving line 100 is touched, mutual capacitance of the sensing lines 200 disposed around the touched point may vary. The sensing unit may calculate a Y-axis coordinate from the sensing lines 200 of which mutual capacitance varies and recognize a specific driving line 100, to which the driving signal is applied, as an X-axis coordinate to calculate the touch coordinate.

Hereinafter, variation in mutual capacitance will be described in detail. Referring to FIG. 3, the mutual capacitance when touch does not occur may be classified into parasitic capacitance coupled in a region in which the driving line 100 and the sensing line 200 overlap each other and a fringe capacitance coupled to surroundings of the overlapping region between the driving line 100 and the sensing line 200.

Here, when the conductor is touched, a portion of the fringe capacitance may be coupled to the conductor and thus removed. Thus, the mutual capacitance may vary. In particular, the mutual capacitance may be reduced by removal of the portion of the fringe capacitance.

That is, as illustrated in FIG. 3, when points at which the driving lines 100 and the sensing lines 200 cross each other are defined as pixels 300, if a specific pixel 300 is touched, mutual capacitance may vary at the specific pixel 300. Thus, the sensing unit may sense a position of the specific pixel 300 to calculate a touch coordinate.

As described above, a method in which X-axis and Y-axis points of the pixel 300 at which the mutual capacitance varies are calculated as a touch coordinate to recognize user's touch may be called a mutual capacitance method. Since the mutual capacitance has a variation that is proportional to that of the fringe capacitance, as the fringe capacitance increases, the touch panel may increase in sensitivity.

However, when each of the sensing lines 200 has a bar shape with a relatively wide width, the parasitic capacitance may increase, thereby reducing the touch sensitivity. On the other hand, when each of the sensing lines 200 has a bar shape with a relatively small width, a distance between the sensing lines 200 that are arranged with each other may increase, thereby deteriorating resolution, or the sensing lines 200 may be densely arranged, and thus, it may be difficult to accurately sense the touch point.

The bar type may have a limitation in which the mutual capacitance of the specific pixel 300 does not linearly vary when the touch point moves within the specific pixel 300. Thus, it may be difficult to measure an accurate coordinate.

Particularly, when the touch is performed by using a stylus pen having a small diameter, it may be difficult to calculate an accurate touch coordinate. When the touched portion moves, the mutual capacitance may not linearly vary according to the movement of the touched portion. Thus, it may be difficult to detect the accurate movement of the touched portion. To solve this problem, the present disclosure provides various embodiments in which the sensing line 200 is changed in shape to improve the accuracy and linearity.

Hereinafter, for convenience of description, a shape of a sensing line 200 within a specific pixel 300 will be described, and descriptions with respect to the sensing line 200 within the specific pixel 300 may be applied to the sensing lines 200 within all pixels 300.

### First Embodiment

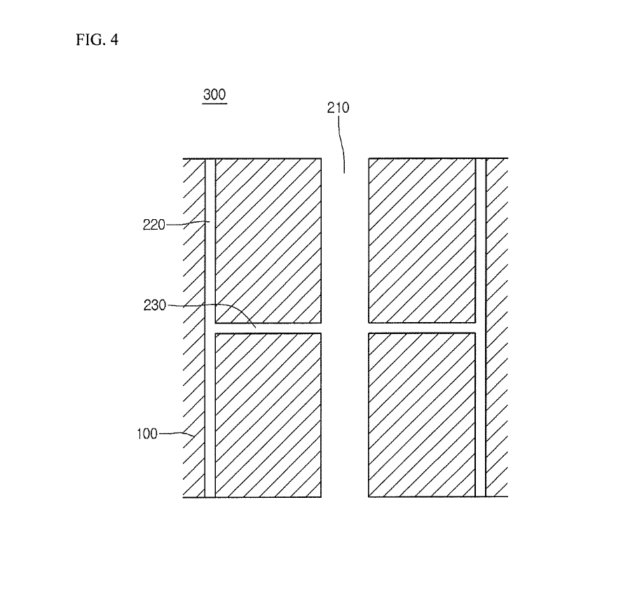

FIG. 4 is a plan view illustrating a pattern of a sensing line in a single pixel in accordance with a first embodiment. Referring to FIG. 4, a sensing line 200 may include a main line 210, a sub line 220, and a branch line 230.

In more detail, the main line 210 may be a transparent electrode having a bar shape to extend in a Y-axis direction. The main line 210 may be connected to main lines of other pixels adjacent in the Y-axis direction. The sub line 220 may be a bar-shaped transparent electrode that is spaced by a particular distance from a side of the main line 210 to extend in the Y-axis direction. For another example, as illustrated in FIG. 4, sub lines 220 may be disposed on each of both sides of the main line 210.

The sub line 220 may have a width less than that of the main line 210. In addition, the sub line 220 may not be connected to sub lines 220 of other pixels 300 that are adjacent in the Y-axis direction. For example, when the main line 210 has a width of approximately 600 μm, the sub line 220 may be a width of approximately 150 pm that corresponds to a quarter of the width of the main line 210.

The branch line 230 may be a transparent electrode that protrudes from a side surface of the main line 210 to extend up to the sub line 220. That is, the branch line 230 may connect the main line 210 with the sub line 220. The branch line 230 may be disposed in a direction crossing the main line 210 and the sub line 220 to connect the main line 210 with the sub line 220 at the shortest distance. Here, the branch line 230 may have a width of approximately 300 μm, corresponding to a half of that of the main line 210. A plurality of branch lines 230 may be provided. For example, the branch line 230 may include a first branch line connecting an upper portion of the main line 210 to an upper portion of the sub line 220 and a second branch line connecting a lower portion of the main line 210 to a lower portion of the sub line 220.

The driving line 100 may be a bar-type transparent electrode. The driving line 100 may be spaced by a particular distance downward from the sensing line 200 to extend in a direction (e.g., an X-axis direction) crossing the main line 210 and the sub line 220.

In summary, the sensing line 200 in the pixel 300 may include a main line 210 extending in the Y-axis direction, sub lines 220 each of which is spaced by a particular distance from each of both sides of the main line 20, and branch lines 230 connecting the main line 210 to the sub lines 220.

The sensing line 200 may increase in circumference, and thus, fringe capacitance may increase in proportion to the increasing length of the sensing line 200. When a touch position gradually moves toward the sub line 220 with respect to the main line 210, mutual capacitance of the pixel 300 may be linearly reduced to thereby accurately detect the touch position. For example, when a first pixel and a second pixel that is disposed at a right side of the first pixel are provided, if the touch position moves from the first pixel to the second pixel, the touch position reaches the sub line of the second pixel from the main line of the first pixel to the sub line of the first pixel, and then to reach the main line of the second pixel.

As described above, since the touch position passes through the main line or sub line always when the touch position moves, the mutual capacitance may increase in variation. Further, the widths of the main line and sub line may be configured to be different from each other to thereby secure linearity in variation of the mutual capacitance according to the touch position.

### Second Embodiment

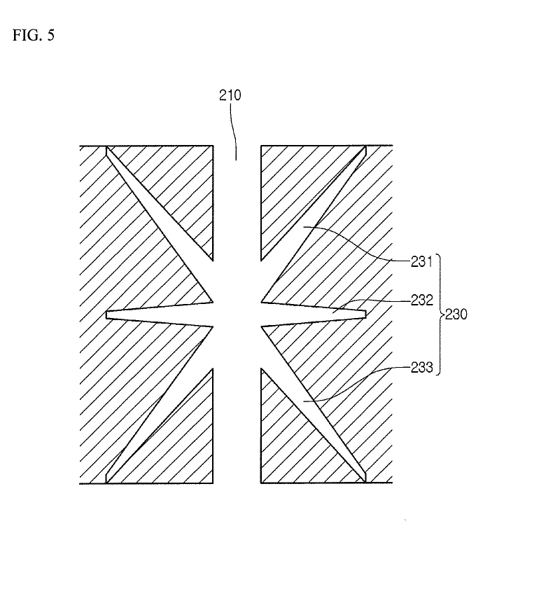

FIG. 5 is a plan view illustrating a pattern of a sensing line in one pixel in accordance with a second embodiment. Referring to FIG. 5, a sensing line 200 may include a main line 210 and a plurality of branch lines 230 extending from the main line 210, which are disposed on the same plane.

In particular, the main line 210 may be a transparent electrode having a bar shape to extend in a Y-axis direction. The main line 210 may be connected to main lines of other pixels 300 adjacent in the Y-axis direction. Each of the branch lines 230 may be a transparent electrode that extends from the main line 210 and is disposed in a pixel region. Here, the pixel region may represent a region within a boundary between a specific pixel 300 and other pixels 300 disposed around the specific pixel 300.

For example, the sensing line 200 may include a second branch line 232 extending from a central portion of the main line 210 in an X-axis direction and first and third branch lines 231 and 233 extending from the central portion of the main line 210 in a diagonal direction with respect to the X-axis and Y-axis directions. Particularly, the branch lines 230 may have a width gradually decreasing in a direction that is away from the main line 210. For example, when the main line 210 has a width of approximately 600 μm, each of one ends of the branch lines 230 connected to the main line 210 may have a width of approximately 300 gm that corresponds to a half of that of the main line 210. Each of the other ends of the branch lines 230 may have a width of approximately 80 μm that corresponds to two fifteenths of the main line 210.

The driving line 100 may be a bar-type transparent electrode. The driving line 100 may be disposed spaced by a particular distance downward from the sensing line 200 to extend in a direction (e.g., an X-axis direction) crossing the main line 210.

In the pixel 300 having the above-described structure, the sensing line 200 may increase in circumferential length to increase fringe capacitance thereof. As the touch point is away from a center of the pixel region, each of the branch lines 230 may decrease in width. Thus, the mutual capacitance may be linearly reduced, thus increasing sensitivity of the device. When a conductor moves in a diagonal direction with respect to the X-axis and Y-axis directions after the conductor is touched, the mutual capacitance may be linearly decreased to thereby accurately recognize a touch pattern.

### Third Embodiment

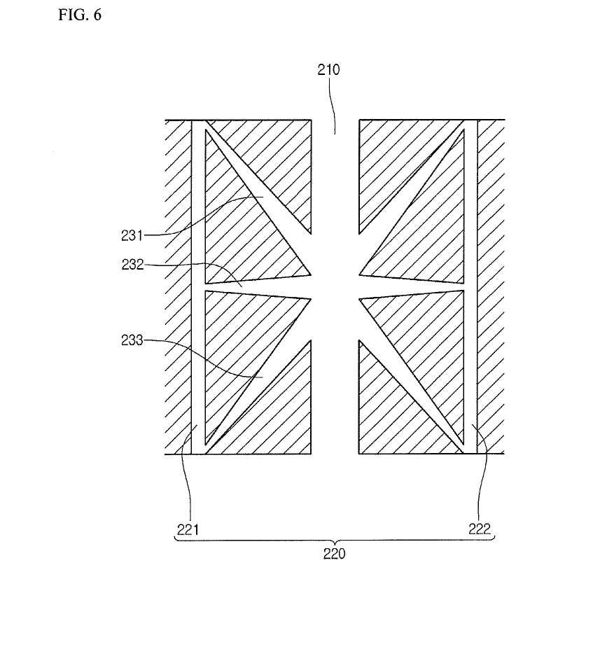

FIG. 6 is a plan view illustrating a pattern of a sensing line in a single pixel in accordance with a third embodiment. Referring to FIG. 6, a sensing line 200 may include a main line 210, a sub line 220, and a branch line 230, which are disposed on the same plane.

In more detail, the main line 210 may be a transparent electrode having a bar shape to extend in a Y-axis direction. The main line 210 may be connected to main lines 210 of other pixels adjacent in the Y-axis direction. The sub lines 220 may be spaced by a particular distance from each other and may be disposed on both sides of the main line 210. The branch lines 230 connecting the main line 210 with the sub lines 220 may be disposed between the main line 210 and the sub lines 220.

For example, the sensing line 200 may include a first sub line 221 spaced by a particular distance from the main line 210 in a left direction and a second sub line 222 spaced by a particular distance from the main line 210 in a right direction. Here, the sub lines 220 may have a width less than that of the main line 210. In addition, the sub lines 220 may not be connected to sub lines 220 of other pixels 300 that are adjacent in the Y-axis direction. The sensing line 200 may include second branch lines 232 extending from a central portion of the main line 210 in an X-axis direction to connect the main line 210 with the sub lines 220 and first and third branch lines 231 and 233 extending from the central portion of the main line 210 in a diagonal direction with respect to the X-axis and Y-axis directions to connect the main line 210 with the sub lines 220.

The branch lines 230 may have a width that gradually decreases as the distance from the main line 210 increases. For example, when the main line 210 has a width of approximately 600 μm, each of the sub lines 220 may have a width of approximately 150 μm, corresponding to a quarter of the width of the main line 210. One end of the branch lines 230 connected to the main line 210 may have a width of approximately 300 μm, corresponding to a half of the width of the main line 210. The other end of the branch lines 230 may have a width of approximately 80 μm, corresponding to two fifteenths of the width of the main line 210. The driving line 100 may be a bar-type transparent electrode. The driving line 100 may be spaced by a particular distance downward from the sensing line 200 to extend in a direction (e.g., an X-axis direction) crossing the main line 210 and the sub lines 220.

In the pixel 300 having the above-described structure, a circumference of the sensing line 200 may be increased to increase fringe capacitance. Since each of the branch lines 230 may gradually decrease in width in a direction in which a touch point is away from a central portion of the pixel region, and the sub line 220 has a width less than that of the main line 210, the mutual capacitance may be linearly reduced in variation in the direction in which the touch point is away from the central portion of the pixel region. When a conductor moves in a diagonal direction as well as the X-axis and Y-axis directions after the conductor is touched, the mutual capacitance may linearly vary to thereby accurately recognize a touch pattern.

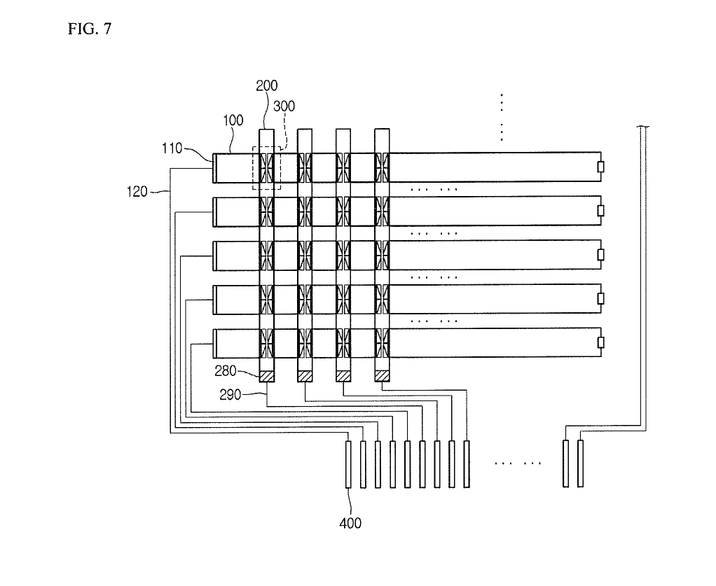

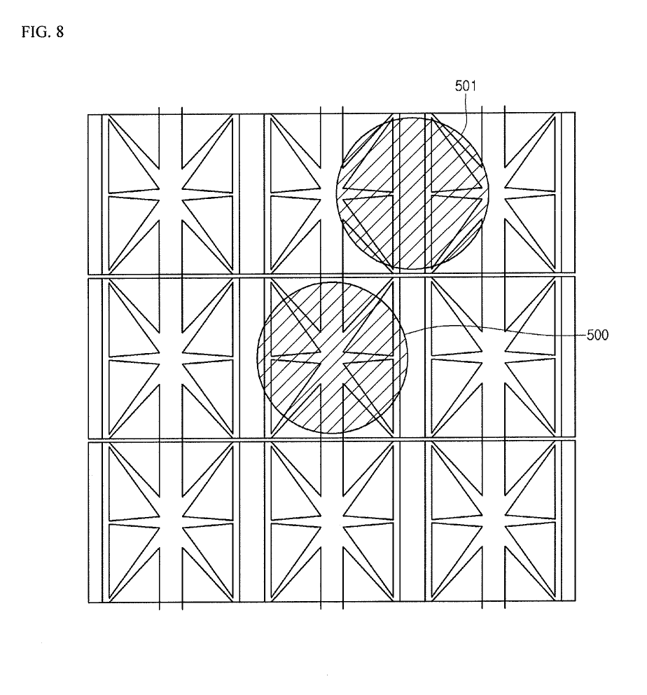

FIG. 7 is a view of a touch panel in accordance with the third embodiment. As illustrated in FIG. 7, a sensing line 200 in accordance with the current embodiment may be applied to each of pixels 300.

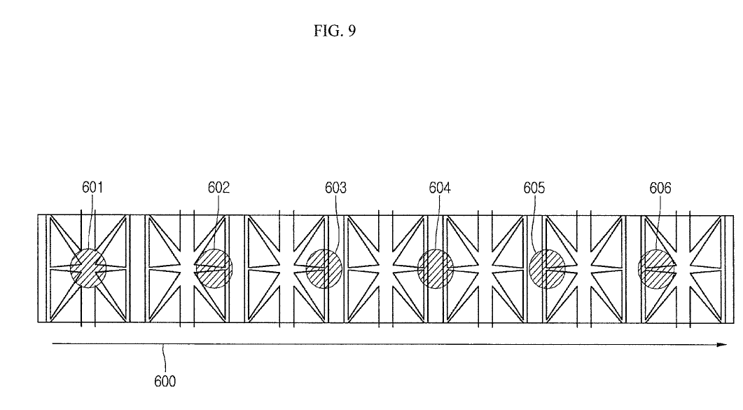

Hereinafter, the advantages of the current embodiment will be described with reference to FIGS. 8 to 10.

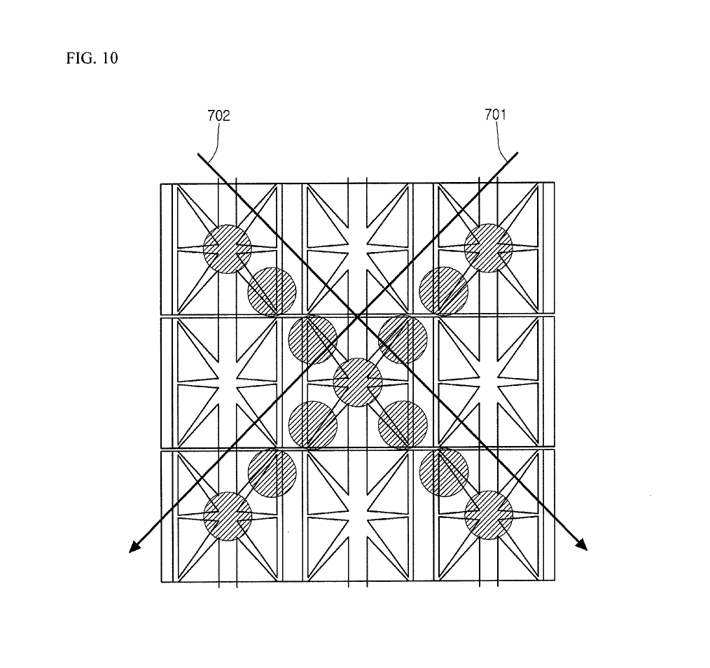

FIG. 8 is a view for explaining a vibration in mutual capacitance when a specific position on the touch panel is touched in accordance with the third embodiment, FIG. 9 is a view for explaining a variation in mutual capacitance when a touch pattern traveling in a horizontal direction is inputted on the touch panel in accordance with the third embodiment, and FIG. 10 is a view for explaining a variation in mutual capacitance when a touch pattern traveling in a diagonal direction is input on the touch panel in accordance with the third embodiment.

Referring to FIG. 8, nine pixels in accordance with the third embodiment are illustrated, and two touches 500 and 501 are inputted on the pixels. First, the first touch 500 may be touched so that one pixel region disposed at a center of the nine pixels is included. Here, the sensing line according to the current embodiment may have a circumferential length, which is greater than that of the general bar-type sensing line, to increase an amount of fringe capacitance. Thus, it is predicted that a large amount of mutual capacitance varies. As such, a sensing unit may more accurately detect the variation in mutual capacitance to improve the touch sensitivity.

The second touch 501 may be touched on a boundary between the pixels. In this case, since the sub lines of the sensing line are disposed on the boundary in the current embodiment, the mutual capacitance of both pixels may increase in variation. As a result, the sensing unit may accurately detect a point touched between both pixels.

Referring to FIG. 9, the pixels in accordance with the third embodiment are disposed in a horizontal direction, and a touch pattern that is dragged by the user in the horizontal direction is inputted. That is, drag touches 601, 602, 603, 604, 605, and 606 may define a drag operation 600. These drag touches 601, 602, 603, 604, 605, and 606 may be input in order of first to sixth touch points 601 to 606.

Here, the touch may pass through the main lines, the branch lines, and the sub lines along the drag 600. The mutual capacitance may linearly vary in each pixel to thereby accurately recognize the touch pattern of the drag operation 600.

Referring to FIG. 10, nine pixels in accordance with the third embodiment are provided, and a touch input reflecting a drag operation performed by the user is performed in a diagonal direction.

When a touch region of a specific pixel senses movement of the user touch in the diagonal direction, the area of sensing line included in the touch region may vary linearly. Thus, it may be predicted that the mutual capacitance also linearly varies, and thus the sensing unit may linearly measure the mutual capacitance in each pixel according to the movement of the user touch to thereby accurately detect the touch pattern.

According to the embodiments as described above, since the sensing line may include the main line, the sub lines, and the branch lines, the sensing line may increase in circumference. Thus, the mutual capacitance may increase in variation. Particularly, when the touch point moves, the mutual capacitance may linearly vary. Therefore, the accuracy and linearity of the touch panel may be significantly improved.

Although the touch panel and touch screen having the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A touch panel for recognizing touch of a conductor, the touch panel comprising:
a driving line extending in a first direction; and
a sensing line disposed on the driving line to extend in a second direction crossing the first direction,
wherein the sensing line comprises a main line extending in the second direction and a plurality of branch lines connected to the main line.

2. The touch panel of claim 1, wherein the sensing line further comprises:
a first sub line spaced by a particular distance from one side of the main line and extending in the second direction; and
a second sub line spaced by a particular distance from another side of the main line to extend in the second direction.

3. The touch panel of claim 2, wherein at least one of the branch lines is connected with one of the first and second sub lines.

4. The touch panel of claim 2, wherein at least one of the first and second sub lines has a width that corresponds to a quarter of a width of the main line.

5. The touch panel of claim 1, wherein at least one of the branch lines extends in the first direction.

6. The touch panel of claim 1, wherein at least one of the branch lines extends in a diagonal direction with respect to at least one of the first and second directions.

7. The touch panel of claim 1, wherein at least one of the branch lines has a branch line width gradually decreasing in a direction that is away from the main line.

8. The touch panel of claim 7, wherein one end of at least one of the branch lines connected to the main line has a branch line width that corresponds to a half of that of the main line, and another end of the at least one of the branch lines has a branch line width that corresponds to two fifteenths of the main line.

9. The touch panel of claim 1, further comprising a driving unit configured to apply a driving signal to the driving line.

10. The touch panel of claim 1, further comprising a sensing unit configured to detect mutual capacitance that varies by the touch to calculate a touch coordinate.

11. A touch screen for recognizing touch of a conductor and outputting an image, the touch screen comprising:
a display;
a driving line disposed on the display to extend in a first direction;
a sensing line disposed on the driving line to extend in a second direction crossing the first direction;
a driving unit configured to apply a driving signal to the driving line; and
a sensing unit configured to detect mutual capacitance that varies by a touch to calculate a touch coordinate, wherein the sensing line comprises a main line extending in the second direction and a plurality of branch lines connected to the main line.

12. The touch screen of claim 11, wherein the sensing line further comprises:
a first sub line spaced by a particular distance from one side of the main line to extend in the second direction; and
a second sub line spaced by a particular distance from another side of the main line to extend in the second direction.

13. The touch screen of claim 12, wherein at least one of the branch lines is connected with at least one of the first and second sub lines.

14. The touch screen of claim 11, wherein at least one of the branch lines extends in the first direction.

15. The touch screen of claim 11, wherein at least one of the branch lines extends in a diagonal direction with respect to at least one of the first and second directions.

16. The touch screen of claim 11, wherein each of the branch lines has a branch line width gradually decreasing in a direction that is away from the main line.
